(19) United States
(12) Patent Application Publication
(10) Pub. No.: US 2016/0284251 A1
(43) Pub. Date: Sep. 29, 2016

(54) CANVAS STRETCHING APPARATUS AND METHOD OF USE THEREOF

(71) Applicant: Daniel RENAUD, Montreal (CA)

(72) Inventor: Daniel RENAUD, Montreal (CA)

(21) Appl. No.: 15/079,247

(22) Filed: Mar. 24, 2016

Related U.S. Application Data
(60) Provisional application No. 62/137,326, filed on Mar. 24, 2015.

(51) Int. Cl. G09F 15/00

(52) U.S. Cl. CPC G09F 15/0025

(57) ABSTRACT

A canvas stretching apparatus is presented, the canvas stretching apparatus comprising a frame for mounting on a mechanical structure, a first tensioning mechanism for lifting the canvas vertically, the first tensioning mechanism being operatively connected to the frame and adapted to connect and pull the canvas vertically, a second tensioning mechanism for stretching the canvas horizontally, the second tensioning mechanism being operatively connected to the frame and adapted to connect and stretch the canvas horizontally, wherein the first and second tensioning mechanisms are actuable independently. A method of stretching a large size canvas is also presented.

### CROSS-REFERENCE

The present application is a non provisional of, and claims priority under 35 U.S.C. 119(e) to, U.S. provisional patent application No. 62/137,326, filed Mar. 24, 2015, entitled CANVAS STRETCHING APPARATUS AND METHOD OF USE THEREOF, which is incorporated herein by reference in its entirety.

### BACKGROUND OF THE INVENTION

1. Field of the Invention

This invention generally relates to an apparatus for stretching canvas. The present invention more specifically relates to an apparatus for stretching large size canvas. The present invention also relates to other features adapted to improve the safety and the efficiency of canvas stretching.

2. Description of the Related Art

Large size canvases, also referred to as mega banners, are increasingly popular. This is caused by the availability of large size canvas printers that are producing canvases of significant sizes.

These canvases can be used for advertising and are large enough to be installed in stadium and on the exterior surfaces of buildings. Large size canvases are cumbersome and are requiring industrial equipment to install the canvas in place and make sure there are no folds in the canvas.

Installation of large size canvas generally requires a crane and a number of people. Sometimes streets need to be blocked to provide enough room for the installation. These operations are costly and are creating traffic jams. Furthermore, the canvas should be adjusted to remove folds therein to provide an optimum visual effect. Stretching a canvas of this size on its frame represents a significant level of complexity.

Installing a large size canvas can become risky if the wind is blowing. A large canvas can act like a sail and it is difficult to maneuver the canvas and the equipment. This can become a critical activity because of, sometimes, short delays and public space installation.

Additionally, the installation is often made at a significant height that implies using lifts and cranes for manipulating the large size canvas. Installation of large size canvases can be made at more than 30 meters high. This is increasing the cost and also the complexity, the time that is required to do the work and the level of risk.

It is therefore desirable to provide an improved canvas stretching apparatus over the existing art.

It is also desirable to provide an improved canvas stretching apparatus over the existing art that is adapted facilitate manipulation of canvases installed at a significant height.

It is equally desirable to provide an improved canvas stretching apparatus over the existing art to keep manipulation of the canvas as low as possible near the ground to increase safety of the operators.

It is desirable to provide an improved canvas stretching apparatus over the existing art that facilitates lateral stretching thereof.

Other deficiencies will become apparent to one skilled in the art to which the invention pertains in view of the following summary and detailed description with its appended figures.

### SUMMARY OF THE INVENTION

One aspect of the present invention is to alleviate one or more of the shortcomings of the background art by addressing one or more of the existing needs in the art.

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention is generally described, in accordance with at least one embodiment thereof, as an improved canvas stretching apparatus and other improvements thereof as described below.

The invention is generally described, in accordance with at least one embodiment thereof, as a canvas stretching apparatus having improved manipulation capability and other improvements thereof caused, at least in part, by an improved design of the canvas stretching apparatus as described below.

The invention is generally described, in accordance with at least one embodiment thereof, as a canvas frame for stretching the canvas thereon that can be manipulated at a height with a reduced level of risks.

The invention is generally described, in accordance with at least one embodiment thereof, as a method of stretching a canvas and other materials with a canvas stretching apparatus having improved canvas manipulation and stretching capability and other improvements thereof caused, at least in part, by an improved design of the canvas stretching apparatus as described below.

The invention is generally described, in accordance with at least one embodiment thereof, as a method of tensing a canvas on a support frame having improved canvas stretching capability and other improvements thereof caused, at least in part, by an improved design of the canvas stretching apparatus allowing manipulation and installation from a lower position from the ground.

The invention is generally described, in accordance with at least one embodiment thereof, as a method of tensing a canvas on a support frame having improved canvas stretching capability and other improvements thereof caused, at least in part, by an improved design of the canvas stretching apparatus allowing manipulation and installation from a unique position in respect with the canvas stretching apparatus.

The invention is generally described, in accordance with at least one embodiment thereof, as an apparatus and a method for vertically and laterally tensing a canvas on a support frame.

The invention is generally described, in accordance with at least one embodiment thereof, as a canvas stretching apparatus adapted to be installed at a significant height and be manipulated without a crane.

Aspects of our work, in accordance with at least one embodiment of the invention, provide an improved canvas stretching apparatus over the existing art that allows for discretely adjusting a lateral tension in the canvas when the canvas is installed in its final position.

Aspects of our work, in accordance with at least one embodiment of the invention, provide a canvas stretching apparatus including a plurality of lateral stretching points adapted to discretely apply tension in the canvas.

Aspects of our work, in accordance with at least one embodiment of the invention, provide a canvas stretching apparatus including a upper member adapted to lift the canvas and lateral members adapted to laterally stretch the canvas, the lifting and the lateral tension adjustment being made from a lower portion of the canvas.

Additional and/or alternative features, aspects, and advantages of embodiments of the present invention will become apparent from the following description, the accompanying drawings, and the appended claims.

### BRIEF DESCRIPTION OF THE DRAWINGS

FIG. 1 is an illustration of a large size canvas assembled to its support frame and installed on a building;

FIG. 2 is a schematic illustration of an exemplary square support frame;

FIG. 3 is a schematic illustration of an exemplary rectangular support frame;

FIG. 4 is a schematic illustration of an exemplary rectangular support frame;

FIG. 5 is a schematic illustration of a canvas being lifted on a support frame;

FIG. 6 is a schematic illustration of the lateral adjustment of canvas on a support frame;

FIG. 7 is a possible embodiment of the assembly of a canvas to the support frame;

FIG. 8 is a schematic illustration of a possible assembly of a canvas and its support frame wherein the user can manage the canvas from a lower and safer position;

FIG. 9 is a schematic illustration of a possible assembly of a canvas and its support frame wherein the user can manage the canvas from a lower and safer position;

FIG. 10 is a schematic illustration of a possible assembly of a canvas and its support frame wherein the user can manage the canvas from a single lower and safer position;

FIG. 11 is a schematic illustration of a possible assembly of a canvas and its support frame wherein the user can manage the canvas from a lower and safer position;

FIG. 12 is a schematic illustration of an assembly of a canvas and its support frame wherein the user is on a lifting apparatus to manage the canvas;

FIG. 13 is a detailed illustration of an embodiment of the assembly of a canvas and a support frame;

FIG. 14 is a detailed illustration of the upper portion of an embodiment of a mechanism to lift and manage a canvas on a support frame;

FIG. 15 is a detailed illustration of the lower portion of an embodiment of a mechanism to lift and manage a canvas on a support frame;

FIG. 16 is a magnified portion of the pulley mechanism used to stretch the canvas on the support frame;

FIG. 17 is a detailed illustration of an embodiment of the stretching system used to stretch the canvas on the support frame;

FIG. 18 is a detailed illustration of an embodiment of the stretching system used to stretch the canvas on the support frame;

FIG. 19 is a detailed illustration of an embodiment of the stretching system used to stretch the canvas on the support frame; and

FIG. 20 is a detailed illustration of an embodiment of the stretching system used to stretch the canvas on the support frame.

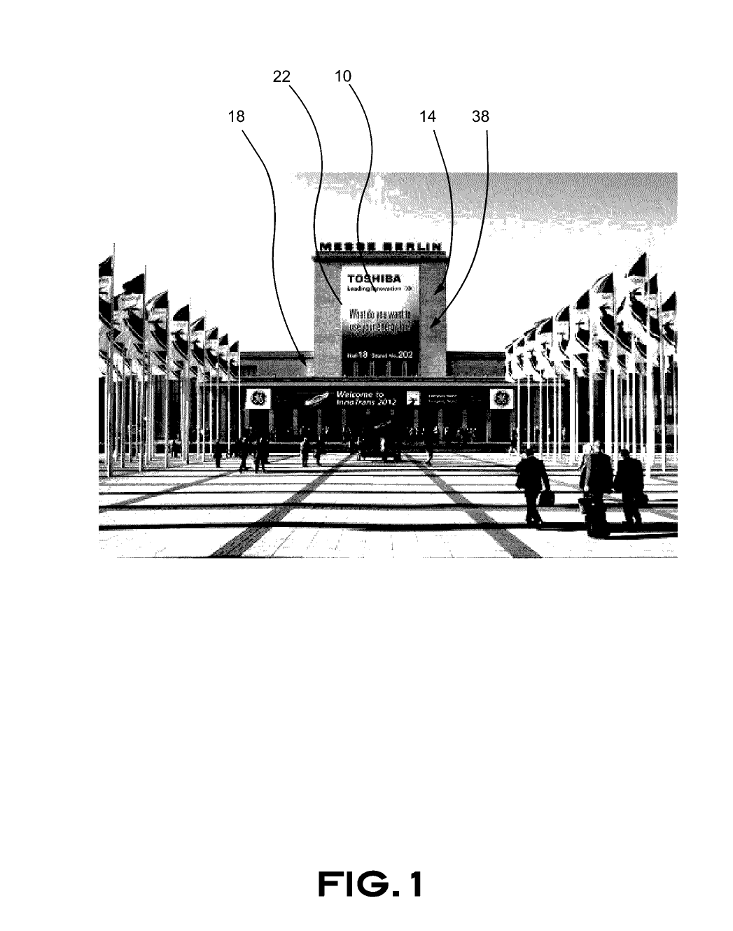

### DESCRIPTION OF EMBODIMENT(S) OF THE INVENTION

Our work is now described with reference to the figures. In the following description, for purposes of explanation, numerous specific details are set forth in order to provide a thorough understanding of the present invention by way of embodiment(s). It may be evident, however, that the present invention may be practiced without these specific details.

Large size canvases 10 are used in various fashions in the industry. One application is advertising in stadiums and on the exterior walls of buildings 14. The size of these canvases 10 can be significantly large and can extend to several tens of meters in width and length. Large size canvases 10 are generally disposed high above the ground 18 for improved visibility and are thus not easy to install and adjust in place. They can be difficult to maneuver and be prone to catch wind, among other obstacles. Moreover, large size canvases 10 generally require heavy and costly machinery to put in place, they are cumbersome to move and install in their desired position.

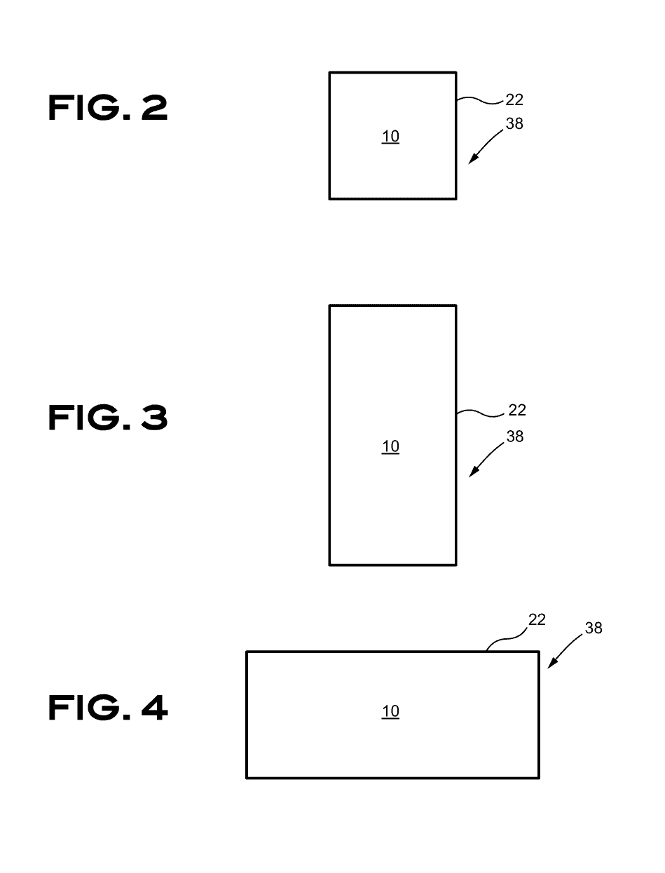

A large size canvas 10 is generally made of a fabric, a polymer layer or any other material suitable to be printed. The canvas 10 is printed with appropriate printer and is installed on a support frame 22 to maintain them in position. The frame 22 is also used to adjust the canvas 10 such that folds are removed and the canvas appears flat and smooth to a viewer. Such a mechanism to prevent formation of folds in the canvas 10 is going to be discussed below in more details. The support frame 22 can come in a variety of sizes and proportions as illustrated on the framed canvas 38 shown in FIG. 2, FIG. 3 and FIG. 4.

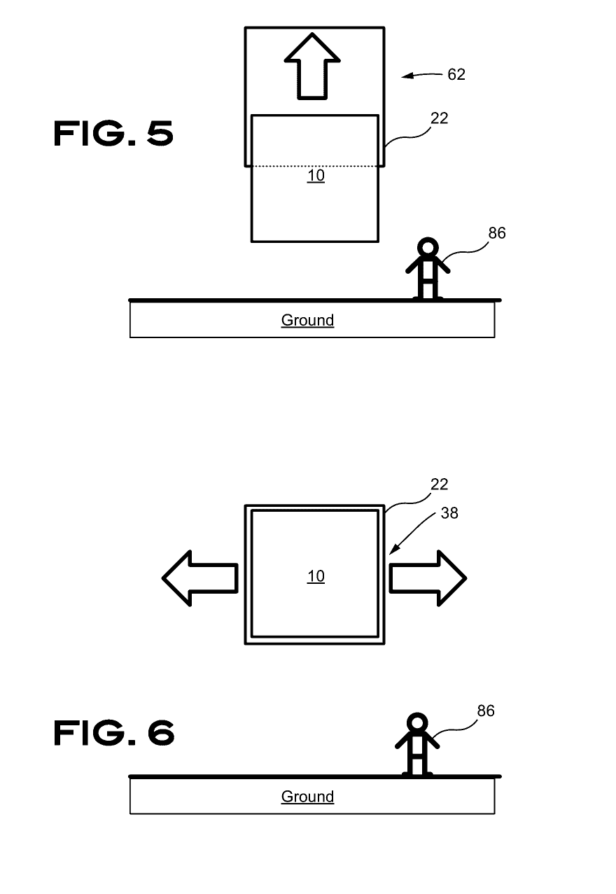

In an embodiment, the canvas 10 can be lifted and positioned in the support frame 22 in a desired position, as illustrated in FIG. 5. Generally, the support frame 22 remains installed on the building (or other mechanical structure). Lateral adjustment of the canvas 10 can then be made to stretch the canvas 10 and remove folds therein. A schematic illustration of lateral adjustment is depicted in FIG. 6.

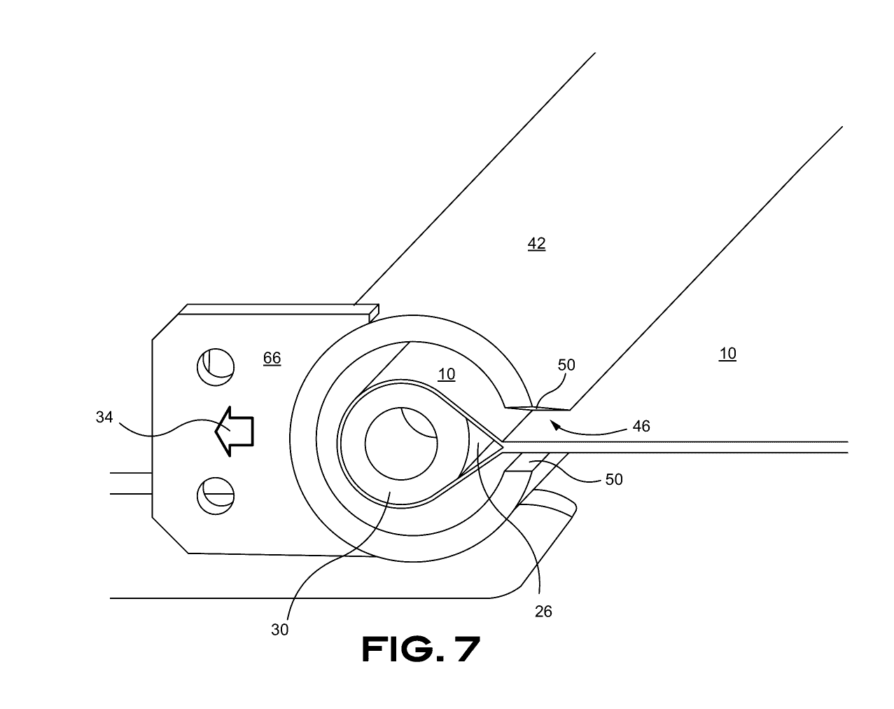

One way to assemble a canvas 10 to a frame 22 is made with a loop 26 of material created in periphery of the canvas 10. A support member 30 is slid and secured inside the canvas loop 26 on top of the canvas 10. Material such as UHMW is desirable as support member 30 because is it easy to slip inside the canvas loop 26 and helps prevent damaging the canvas 10. The support member 30 with the canvas 10 is then inserted inside a receiving member 42, allowing passage of the canvas 10 through a slot 46, which can be appreciated in FIG. 7. A beveled portion, or a chamfer 50, is manufactured on edges of the receiving member 42 to further protect the canvas 10 when sliding the canvas 10 in the slot 46. Once the upper portion of the canvas 10 is in place in the receiving member 42, the canvas 10 is lifted in place with the first mechanism 62 pulling on receiving member connectors 66. Lifting the canvas 10 is done by a first mechanism 62 adapted to lift and lower the canvas 10. The first mechanism 62 is pulling and lifting the support member 30 and receiving member 42 assembly of the upper side of the canvas 10 in the frame 22 that is already installed in a desired viewing position.

The lateral sides 58 of the canvas 10, in which respective support members 30 are assembled, are progressively inserted in corresponding receiving members 42 along with the vertical movement securing the canvas 10 in the frame 22. The lower portion of the canvas 10 is also equipped with a support member 30 that is also inserted inside a receiving member 42, allowing passage of the canvas 10 through the slot 46 performed therein. Once the upper portion and the lower portion of the canvas 10 is secured in the frame 22, vertical tension can be applied to the canvas 10 via the upper receiving member 42 and the lower receiving member 42 to stretch the canvas 10 in place in the frame 22.

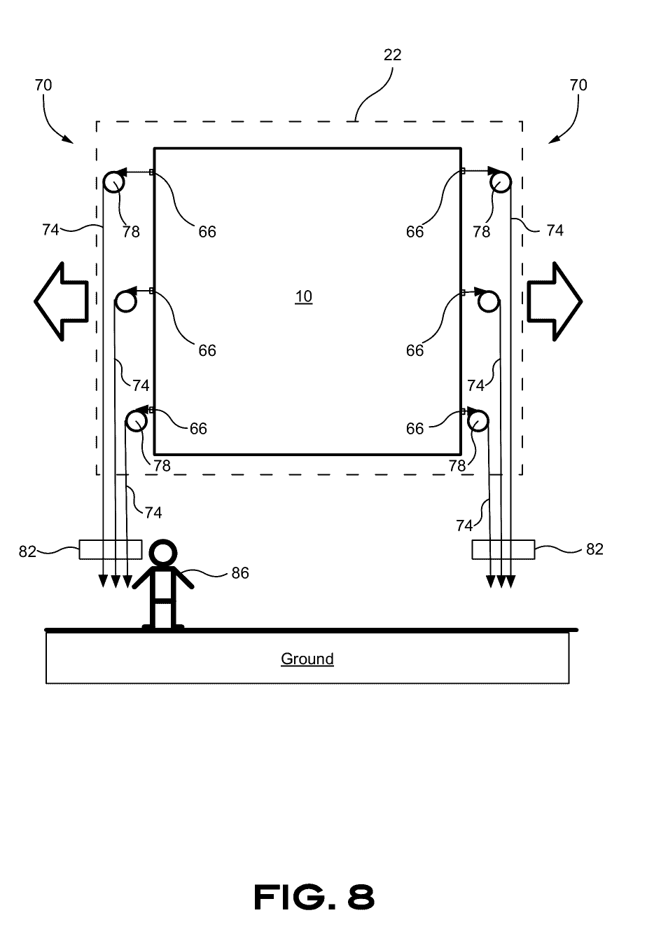

The receiving members 42 on the four sides of the canvas 10 secure the complete periphery of the canvas 10 in the frame 22. A second mechanism 70 is used to laterally stretch the canvas 10. An exemplary second mechanism 70 is exemplified in FIG. 8. A plurality of steel wires 74 are respectively connected to receiving member connectors 66 disposed over the length of the lateral receiving members 42. Steel wires 74 are used throughout the specification to lighten the text however, cords, ropes, composite material wires, chains or the like remain contemplated as suitable equivalents means to actuate the mechanisms that remain within the scope of the present application and could alternatively be used in other unillustrated embodiments without departing from the invention. One can appreciate that the ropes, composite wires, cables or the like, can alternatively replace the steel wires 74 without departing from the scope of the invention. Pulleys 78 transmit the horizontal tension of the wires 74 vertically. The number of receiving member connectors 66 can vary depending on the tension distribution that is expected on the canvas 10 and the size of the canvas 10. In FIG. 8, each receiving member connectors 66 can be pulled independently thus allowing the application of different tensions at the different receiving member connectors 66 to properly adjust the canvas 10 and remove possible folds therein. A locking mechanism 82 is used to lock in place each wire 74 collectively or independently to the frame 22 or a fixed structure. The steel wires 74 can be extended lower than the frame 22 and be available for manipulation by a user 86 from a lower position or even from ground level. The lower position of the user 86 is safer and management of the canvas 10 is easier.

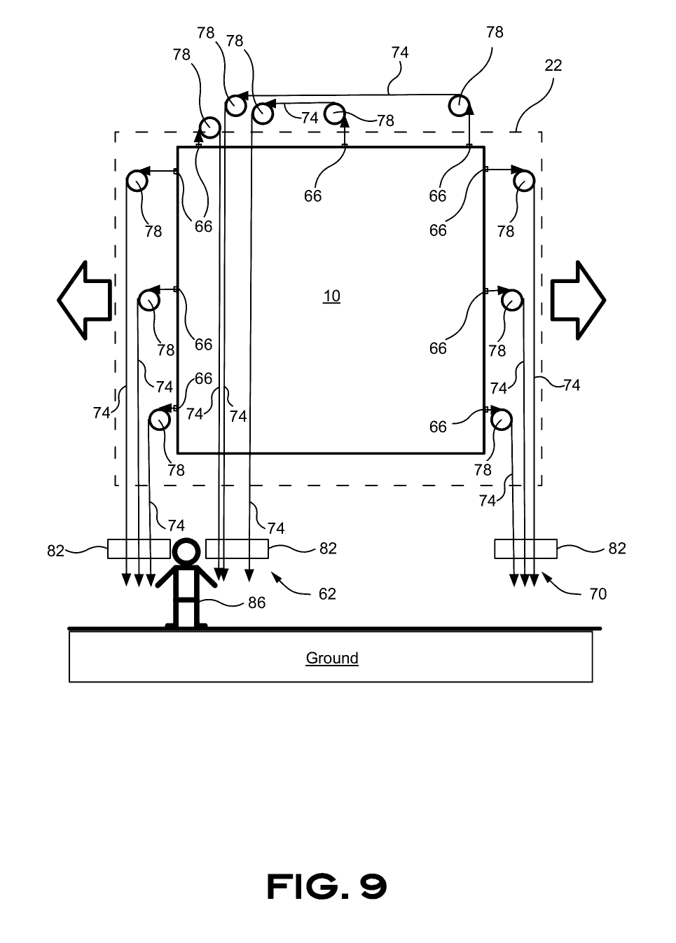

FIG. 9 illustrates an alternate embodiment depicting the first mechanism 62 in cooperation with the second mechanism 70 discussed above. A similar wires 74 and pulleys 78 system is used in conjunction with a locking mechanism 82 securing the wires 74 in the desired position.

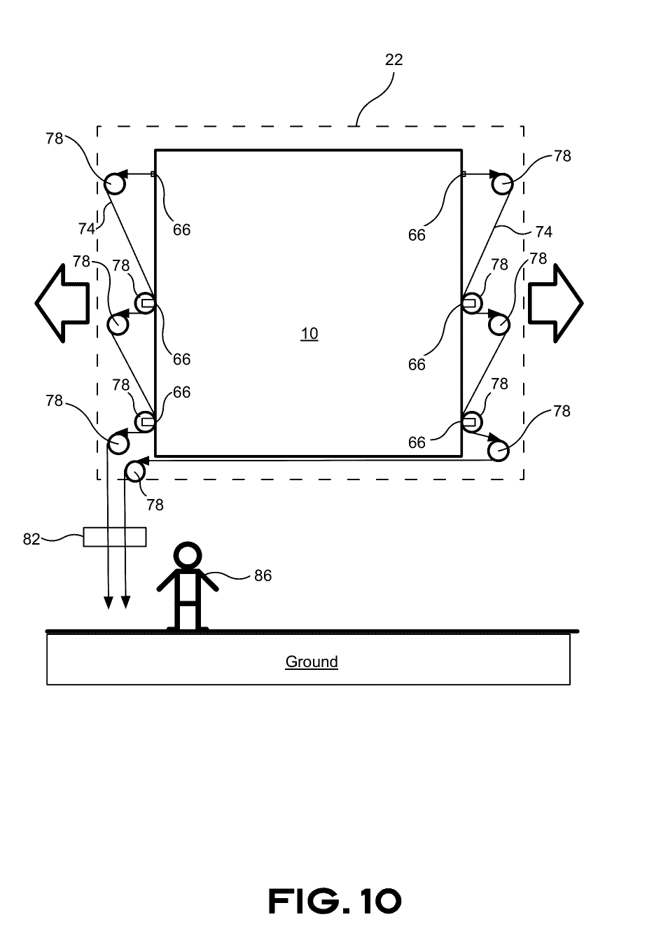

Moving now to FIG. 10 illustrating an embodiment using a single steel wire 74 to apply tension on the canvas 10. The embodiment of FIG. 9 provides the same tension on each receiving member connectors 66. A similar wires 74 and pulley 78 system is used in conjunction with a locking mechanism 82 securing the wires 74 in the desired position.

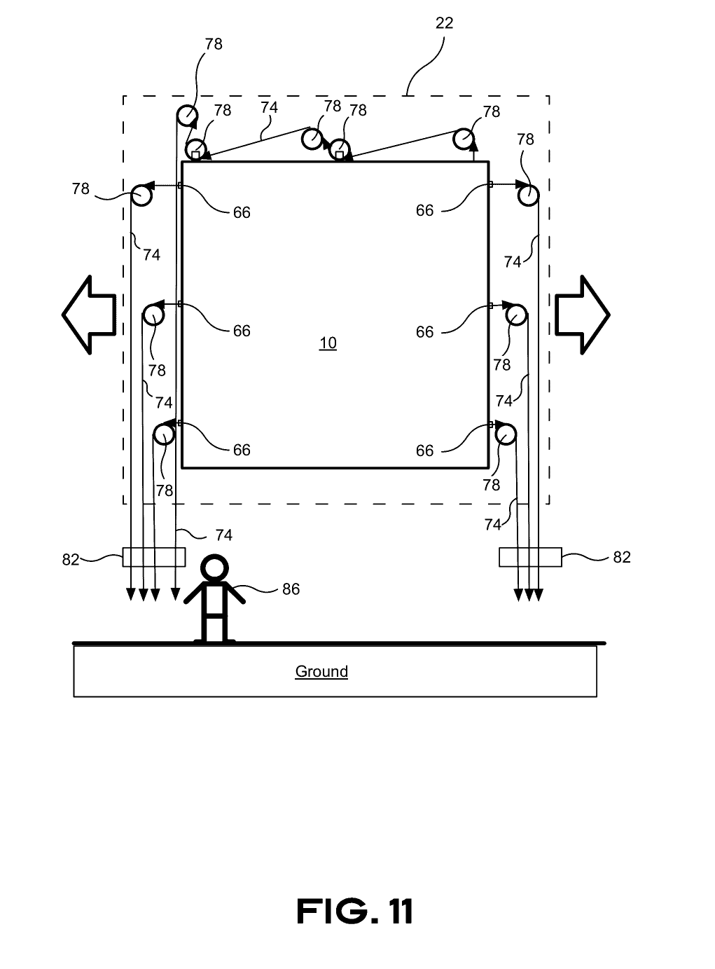

FIG. 11 illustrates an alternate embodiment depicting the first mechanism 62 in cooperation with the second mechanism 70 discussed above. This embodiment provides the same tension on each receiving member connectors 66 of the first mechanism 62. A similar wires 74 and pulleys 78 system is used in conjunction with a locking mechanism 82 securing the wires 74 in the desired position.

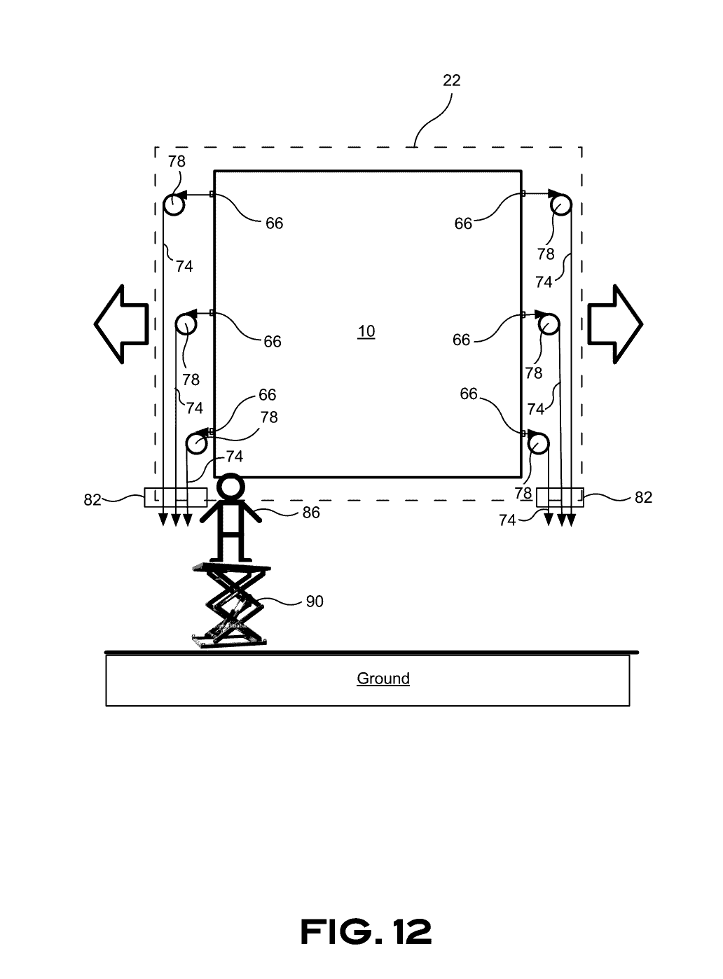

The locking mechanism 82 illustrated in FIG. 12 is elevated from the ground and the user 86 can reach it using an elevated platform 90. The user 86 could alternatively use other lifting apparatus like a ladder.

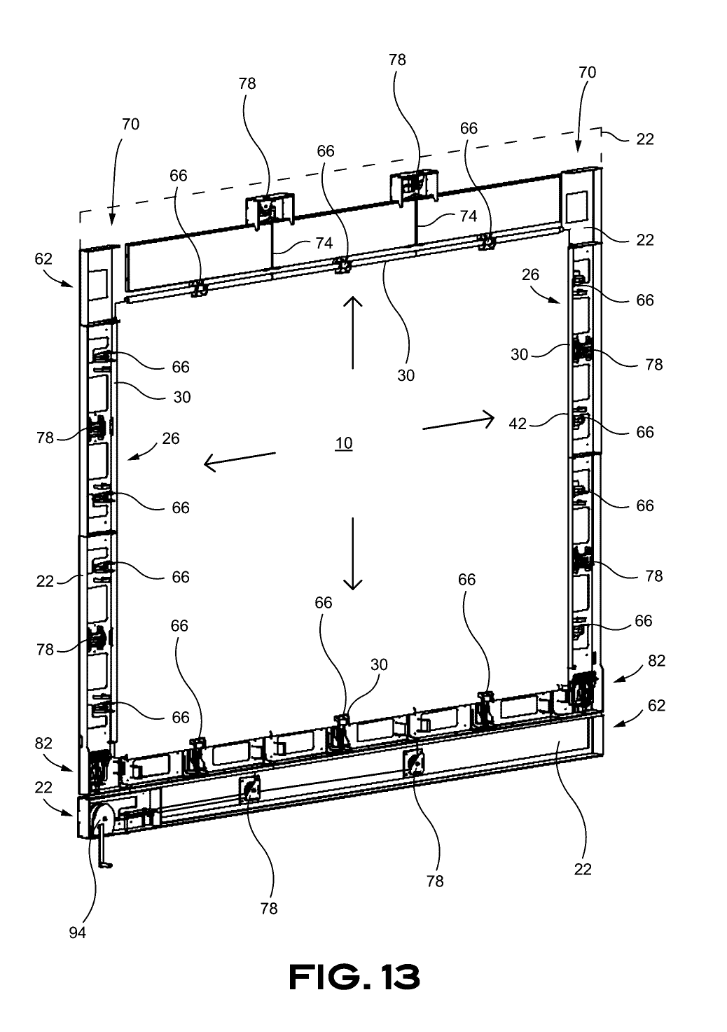

A more detailed embodiment is illustrated in FIG. 13. All the components identified above are present in addition to a manual pulling device 94. The pulling device 94 could alternatively be motorized with apparatus of doing so available in the art.

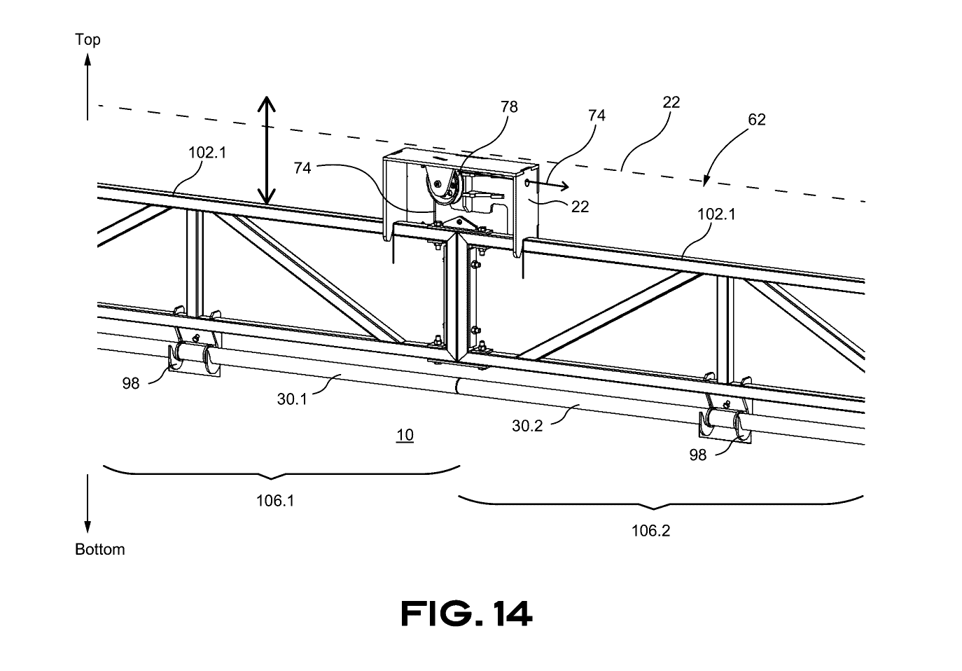

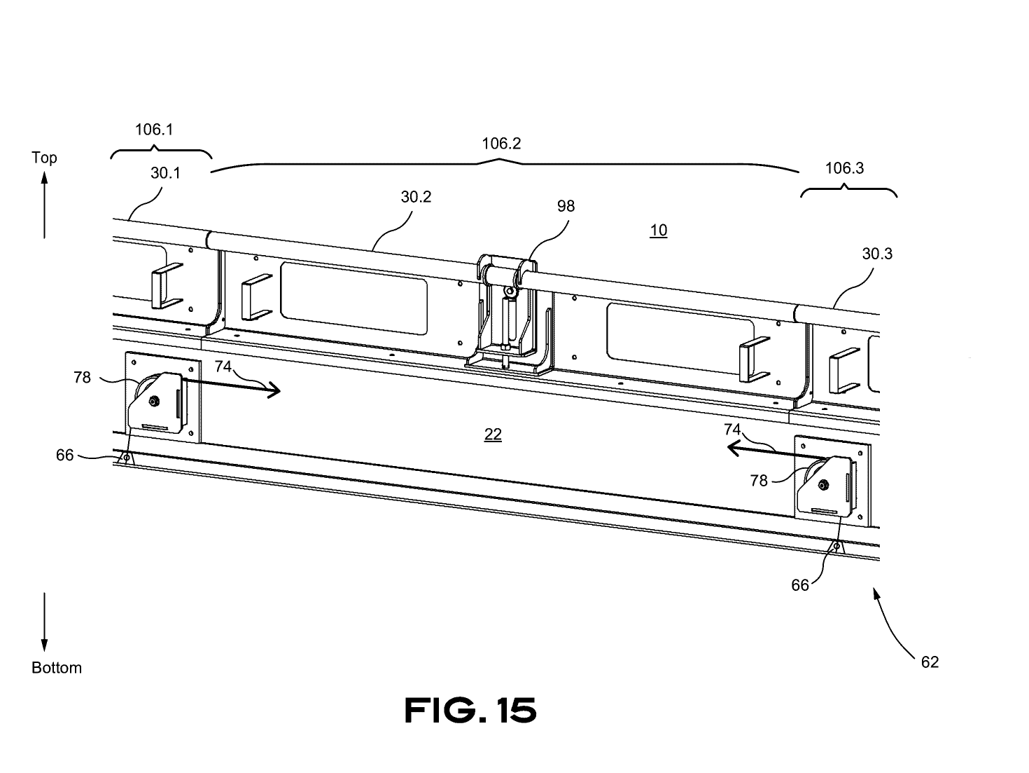

FIG. 14 depicts an upper portion of the first mechanism 62. The canvas 10 is secured to the first mechanism 62 using hooks 98 removably engaging to the support member 30 at discrete locations along the width of the canvas 10. The hooks 98 are secured to a support 102 that is pulled by a plurality of steel wires 74 operatively connected to pulleys 78 to reach a corresponding locking mechanism 82 (not illustrated). It can also be appreciated the support member 30 and the support 102 are modular to accommodate canvas 10 of different sizes. A first module 106.1 is assembled to a second module 106.2 in FIG. 14. In contrast, FIG. 15 illustrates a lower portion of the first mechanism 62.

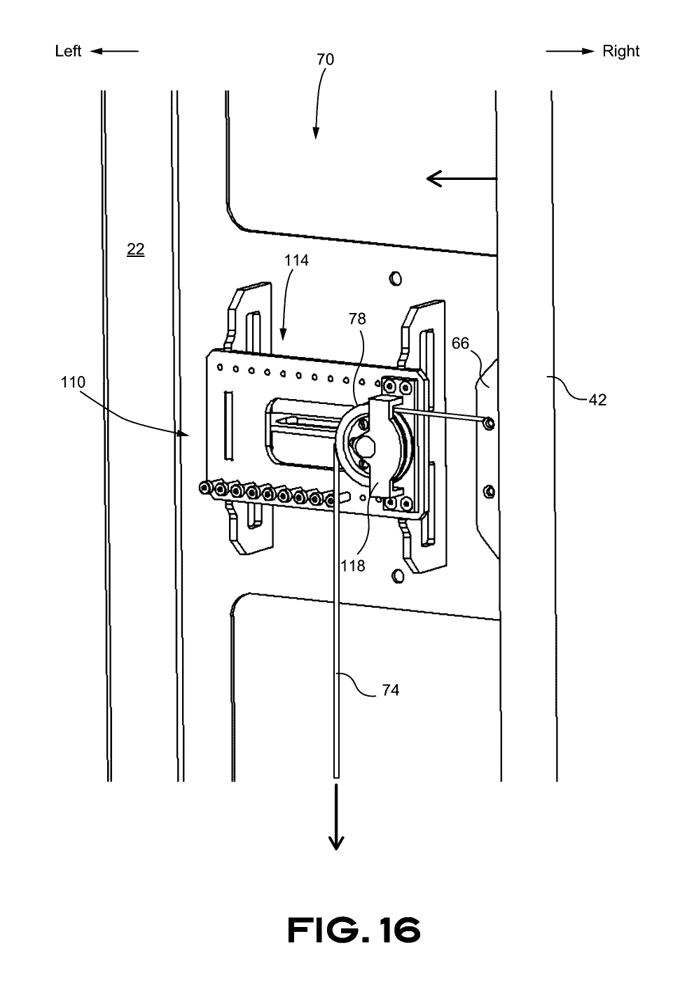

FIG. 16 is a magnified portion of a pulley positioning system 110 suitable to laterally locate the pulley 78 so that each pulley 78 can be aligned properly to prevent cables 74 overlapping. A series of securing locations 114 provide a plurality of securing positions for the pulley support 118.

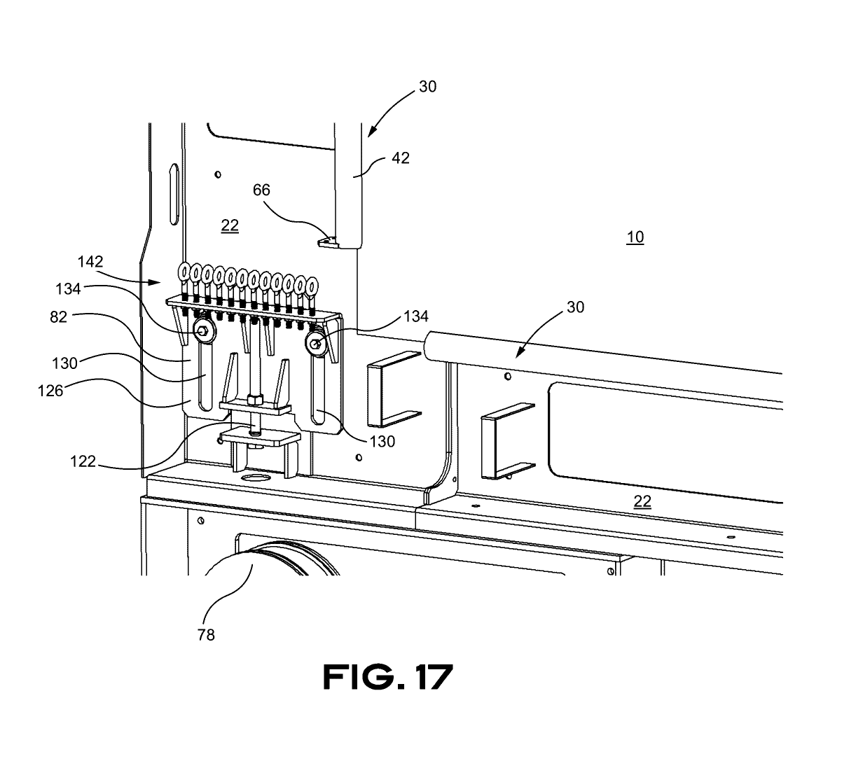

A locking mechanism 62 is embodied in FIG. 17. The locking mechanism 62 comprises a collective pulling mechanism 122 allowing pulling all steel wires 74 connected to the locking mechanism 82 to be pulled together. A movable support 126 guided with slots 130 and securable with fasteners 134 is operatively connected to the frame 22. In contrast, an individual pulling mechanism 138, embodied as a series of individual wire anchors 142 that are used to fine tune tension in individual wires. The individual wire anchors are embodied in the present description as threaded fasteners 142 to which each cable 74 is secured individually for individual adjustment. The plurality of threaded fasteners 142 is secured to the collective pulling mechanism 122. Each threaded fastener 142 can be adjusted individually. Both the collective pulling mechanism 122 and the individual pulling mechanism 138 can be used in conjunction with each other.

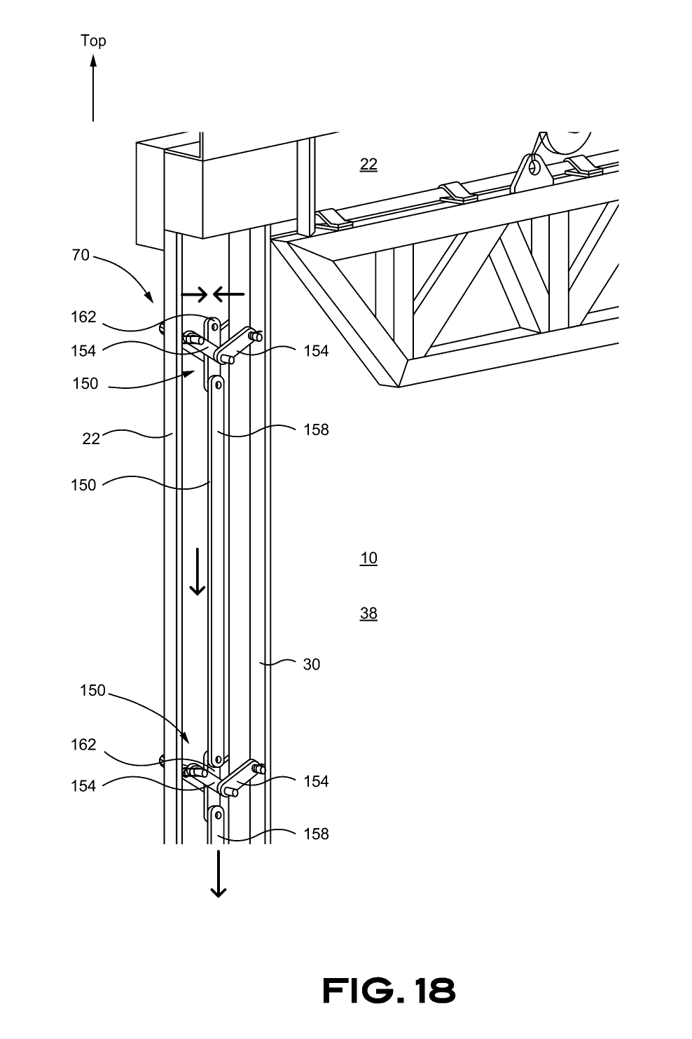

Another embodiment is illustrated in FIG. 18. The second mechanism 70 embodied in FIG. 18 uses a series of members 150 assembled in a fashion adapted to laterally stretch the canvas 10 while applying a tension downward on the mechanism. A pair of short members 154 are operatively laterally connected together and linked to a long member 158 configured to move vertically. The pair of short members 154 are getting at an angle thereof when pulled downward by the long member 158 hence shortening the distance between the support member 30 holding the canvas 10 thereon and the frame 20. Tension in the canvas 10 is function of tension applied in the long member 158. In the illustrated embodiment, an optional additional short member 162 is used in the assembly to add further movement between the long member 158 and the short members 154 assembly. The same mechanism is used on the other side of the canvas 10 to pull both sides of the canvas 10 and thus provides a more precise adjustment of the canvas 10 on the frame 22.

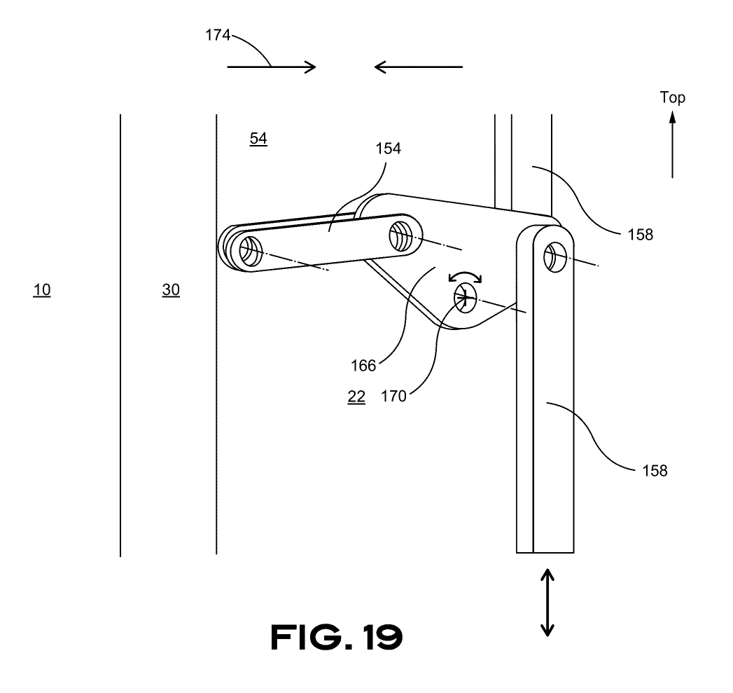

An alternate embodiment is illustrated in FIG. 19. This time, the long members 158 are connected to a pivot member 166 secured via a pivot 170 pivotally secured to the frame 22. The vertical movements of the long members 158 are translating into a change in the lateral stretching 174 of the canvas 10.

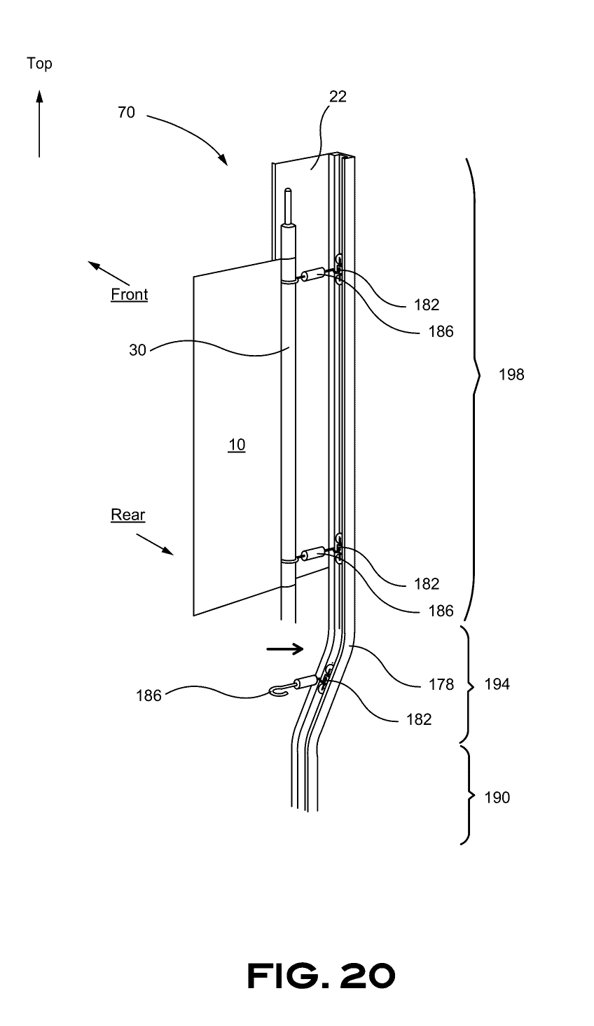

One other embodiment providing a second mechanism 70 adapted to stretch a canvas 10 is exemplified in FIG. 20. A laterally extending rail 178 accommodates therein bearing members 182 sliding upon a vertical movement of the canvas 10 pulled by the first mechanism 62 (not illustrated in FIG. 20). The canvas 10 is laterally connected to the rail 178 by spring members 186 to further distribute tension along the canvas 10 when tension is exercised on the canvas 10 by the vertical movement of the bearing members 182 moving from a narrow portion 190 to a wider portion 198 above via a transition portion 194. The canvas 10 is entirely stretched when it completely reaches the upper wider portion 198 between the rails 178.

The description and the drawings that are presented above are meant to be illustrative of the present invention. They are not meant to be limiting of the scope of the present invention. Modifications to the embodiments described may be made without departing from the present invention, the scope of which is defined by the following claims:

What is claimed is:

1. A canvas stretching apparatus comprising:
a frame for mounting on a mechanical structure;
a first tensioning mechanism for lifting the canvas vertically, the first tensioning mechanism being operatively connected to the frame and adapted to connect and pull the canvas vertically; and
a second tensioning mechanism for stretching the canvas horizontally, the second tensioning mechanism being operatively connected to the frame and adapted to connect and stretch the canvas horizontally, wherein the first and second tensioning mechanisms are actuable independently.

2. The canvas stretching apparatus of claim 1, wherein the first tensioning mechanism includes a plurality of wires lifting a support to which is secured an upper portion of the canvas.

3. The canvas stretching apparatus of claim 2, wherein the upper portion of the canvas includes a loop for receiving a member therein, the member being connected to the plurality of wires of the first tensioning mechanism to substantially evenly transfer tension from the plurality of wires to the canvas.

4. The canvas stretching apparatus of claim 1, wherein the second tensioning mechanism includes a plurality of wires for laterally pulling opposed lateral portions of the canvas and stretch the canvas to remove folds thereon.

5. The canvas stretching apparatus of claim 4, wherein the lateral portions of the canvas respectively include a loop for receiving a member therein, the member being connected to the plurality of wires to substantially evenly transfer tension from the plurality of wires to the canvas.

6. The canvas stretching apparatus of claim 5, wherein the second tensioning mechanism includes a plurality of individual pullers for individually tensing the plurality of wires with different tensions therein to adjust the canvas and remove folds therein.

7. The canvas stretching apparatus of claim 6, wherein the plurality of pullers is collectively adjustable to collectively tense the plurality of wires with a collective pulling mechanism.

8. The canvas stretching apparatus of claim 4, wherein the second tensioning mechanism includes a wire locking mechanism for locking the wires with respective desired tension therein.

9. The canvas stretching apparatus of claim 1, wherein the first tensioning mechanism for stretching the canvas vertically and the second tensioning mechanism for stretching the canvas horizontally are actuable from a location lower than the frame of the canvas stretching apparatus.

10. The canvas stretching apparatus of claim 9, wherein the first tensioning mechanism for stretching the canvas vertically and the second tensioning mechanism for stretching the canvas horizontally are actuable from a location lower than the frame of the canvas stretching apparatus.

11. A method of stretching a large size canvas, the method comprising:
connecting an upper portion of a canvas to a first tensioning mechanism;
actuating the first lifting mechanism to lift the upper portion of the canvas;
connecting lateral portions of the canvas to a second tensioning mechanism; and
actuating the second tensioning mechanism to laterally stretch the canvas.

12. The method of claim 11, further comprising
connecting a lower portion of a canvas to a first tensioning mechanism; and
actuating the first lifting mechanism to vertically stretch the canvas.

13. The method of claim 11, further comprising collectively pulling a plurality of wires to actuate the first lifting mechanism to lift the upper portion of the canvas.

14. The method of claim 11, further comprising collectively pulling a plurality of wires to actuate the second lifting mechanism to laterally stretch the canvas.

15. The method of claim 11, further comprising individually pulling at least some of the plurality of wires to discretely actuate the second lifting mechanism to laterally stretch the canvas for removing folds in the canvas.
